(19) United States
(12) Patent Application Publication
(10) Pub. No.: US 2010/0109559 A1
(43) Pub. Date: May 6, 2010

(54) METHOD AND CIRCUIT OF CONTROLLING AN LED CHARGE PUMP DRIVING CIRCUIT

(76) Inventors: Chih-Chia Chen, Taipei City (TW); Yu-Lee Yeh, Taipei County (TW); Kun-Huang Jheng, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/329,633

(22) Filed: Dec. 7, 2008

(30) Foreign Application Priority Data
Oct. 31, 2008 (TW) 097141973

(51) Int. Cl. H05B 41/36

(52) U.S. Cl. 315/294; 315/291

(57) ABSTRACT

An LED charge pump driving circuit includes a charge pump, a control circuit, a driver, and an LED. The charge pump generates an output voltage according to an input voltage. The driver drives the LED according to the output voltage so as to generate a load voltage. When the load voltage is greater than a first predetermined voltage, the charge pump is turned on. When the load voltage is smaller than a second predetermined voltage over a predetermined duration, the charge pump is turned off. When the load voltage is greater than a third predetermined voltage, the driver is locked.

### BACKGROUND OF THE INVENTION

1. Field of the Invention

The present invention relates to a method of driving a Light Emitting Device (LED), and more particularly, to a method of controlling an LED charge pump driving circuit.

2. Description of the Prior Art

A conventional method of driving an LED includes using driving circuits based on a charge pump or an inductor. A charge pump driving circuit is also called a switched-capacitor driving circuit, and mainly utilizes a capacitor to transmit power from an input end to an output end without involving any inductors. Besides, the charge pump has a small size and a simple circuit. In this way, selection of circuit components of the charge pump driving circuit usually includes suitable capacitors according to related component specifications. Therefore, the charge pump driving circuit is the most popular method for driving the LED.

Please refer to FIG. 1. FIG. 1 is a diagram illustrating a conventional LED charge pump driving circuit 10. When an input voltage Vᵢₙ of the charge pump driving circuit 10 is too high or too low, or under heavy disturbance conditions, the input voltage Vᵢₙ is not suitable for driving the LED 18 directly. Consequently, the charge pump driving circuit 10 is required for generating a suitable and stable output voltage Vₒᵤₜ. The charge pump driving circuit 10 comprises a charge pump 12, a control circuit 14 and a current sink 16. The charge pump 12 stores charges of an input end and transmits the charges to an output end with a capacitor and a switch so as to generate the output voltage Vₒᵤₜ at a level greater than the input voltage Vᵢₙ for driving the LED 18. The current sink 16 is used to provide a constant current to each of the LEDs 18. The control circuit 14 is capable of controlling the charge pump 12 and the current sink 16 is capable of adjusting magnitude of the current passed to the LED 18.

Although the conventional charge pump driving circuit 10 is capable of providing a constant output voltage Vₒᵤₜ to the LED 18, the charge pump driving circuit 10 is unable to control the luminance of the LED 18 effectively, since the luminance of the LED 18 is determined by the driving current instead of the driving voltage. Additionally, the charge pump driving circuit 10 usually generates excessively large transient output voltage Vₒᵤₜ in order to ensure that the LED 18 turns on. However, this lowers driving efficiency of the charge pump driving circuit 10.

### SUMMARY OF THE INVENTION

The present invention provides a method of controlling the LED charge pump driving circuit. The method comprises inputting an input voltage to a charge pump for generating an output voltage; using a driver for driving an LED for generating a loading voltage according to the output voltage. When the loading voltage is greater than a first predetermined voltage, the charge pump is turned on. When the loading voltage is smaller than a second predetermined voltage, the charge pump is turned off. When the loading voltage is greater than a third predetermined voltage, the driver is locked.

The present invention further provides a method of controlling the LED charge pump driving circuit. The method comprises inputting an input voltage to a charge pump for generating an output voltage; using a plurality of driver for driving a plurality of LEDs according to the output voltage and detecting a plurality of loading voltages of the plurality of drivers. When one of the plurality of loading voltages is greater than the first predetermined voltage, the charge pump is turned on. When all the plurality of loading voltages are smaller than the second predetermined voltage, the charge pump is turned off. When the loading voltage of the driver is greater than the third predetermined voltage, the driver is locked.

The present invention further provides an LED charge pump driving circuit. The charge pump driving circuit comprises a charge pump, a driver, a current mirror, a first resistor, a second resistor, a third resistor, a first comparator, a second comparator, and a third comparator. The charge pump comprises an input end and an output end. The driver is electrically connected to the output end for generating a loading voltage for driving an LED. The current mirror provides a reference current. The first resistor is electrically connected to the input end for generating a first predetermined voltage according to the reference current. The second resistor is electrically connected to the first resistor for generating a second predetermined voltage according to the reference current. The third resistor is electrically connected to output end for generating a third predetermined voltage according to the reference current. The first comparator compares the loading voltage and the first predetermined voltage for generating a first controlling signal. The second comparator compares the loading voltage and the second predetermined voltage for generating a second controlling signal. The third comparator compares the loading voltage and the third predetermined voltage for generating a third controlling signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional LED charge pump driving circuit.

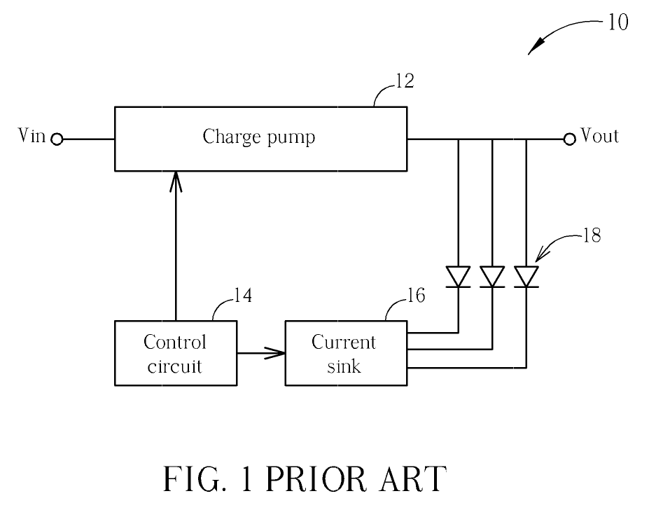

FIG. 2 is a block diagram illustrating the LED charge pump driving circuit of the present invention.

FIG. 3 is a circuit diagram illustrating a driver of FIG. 2.

FIG. 4 is a flow chart illustrating a method of utilizing a single driver for controlling the LED charge pump driving circuit of the present invention.

FIG. 5 is a flow chart illustrating a method of utilizing a plurality of drivers for controlling the LED charge pump driving circuit of the present invention.

FIG. 6 is a circuit diagram of the control circuit embodying FIG. 4 and FIG. 5 of the present invention.

### DETAILED DESCRIPTION

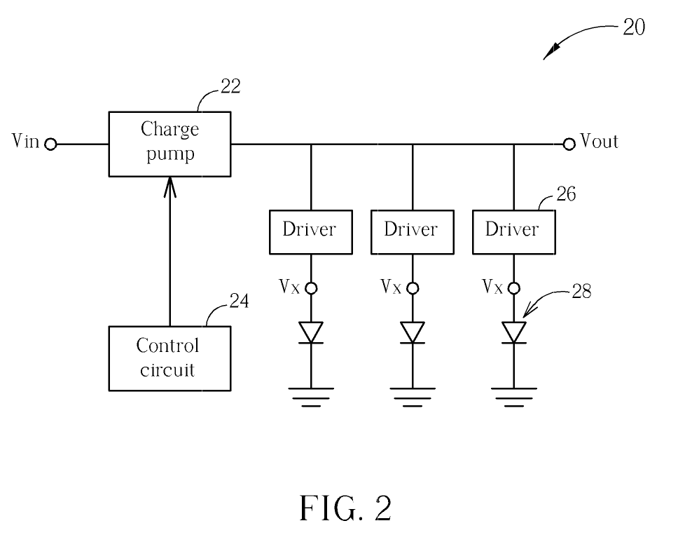

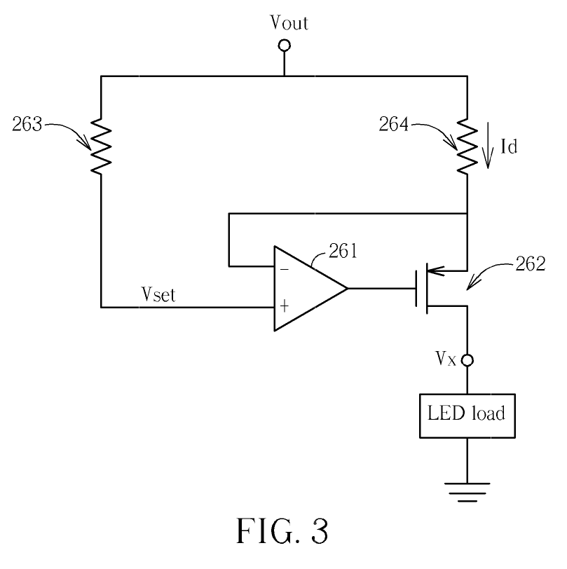

Please refer to FIG. 2 and FIG. 3. FIG. 2 is a block diagram illustrating an LED charge pump driving circuit 20 of the present invention, and FIG. 3 is a circuit diagram illustrating a driver of FIG. 2. As shown in FIG. 2, the charge pump driving circuit 20 comprises a charge pump 22, a control circuit 24, a plurality of drivers 26, and a plurality of LEDs 28. In this embodiment of the present invention, the control circuit 24 turns the charge pump on/off according to the loading voltage Vx of a plurality of LEDs 28. Further, the control circuit 24 determines whether the driver is open-circuited or not according to the loading voltage Vx of a plurality of LEDs 28, namely whether the driver 26 is not electrically connected to the LED or whether the LED electrically connected to the driver is burned out. When the charge pump 24 determines that the driver 26 is open-circuited, the driver 26 is locked. After the driver 26 is locked, the control circuit 24 discontinues performing operations based on the loading voltage Vx of the driver 26. When the charge pump 22 is turned on, the charge pump 22 can generate an output voltage Vₒᵤₜ which is greater than the input voltage Vᵢₙ (Vₒᵤₜ=M*Vᵢₙ). As shown in FIG. 3, each of the drivers 26 comprises an operational amplifier 261, a PMOS transistor 262, a first resistor 263, and a second resistor 264. A drain of the PMOS transistor 262 is electrically connected to the LED 28, a source of the PMOS transistor 262 is electrically connected to a negative input end of the operational amplifier 261, and a gate of the PMOS transistor 262 is electrically connected to the output end of the operational amplifier 261. The first resistor 263 is electrically connected between the output end of the charge pump 22 and the positive input end of the operational amplifier 261. The second resistor 264 is electrically connected between the output end of the charge pump 22 and the negative input end of the operational amplifier 261. The driver 26 generates a set voltage Vₛₑₜ and a driving current I_{d} with the first resistor 263 and the second resistor 264, and the operational amplifier 261 controls the PMOS transistor 262 for outputting the driving current Id for driving the LED 28.

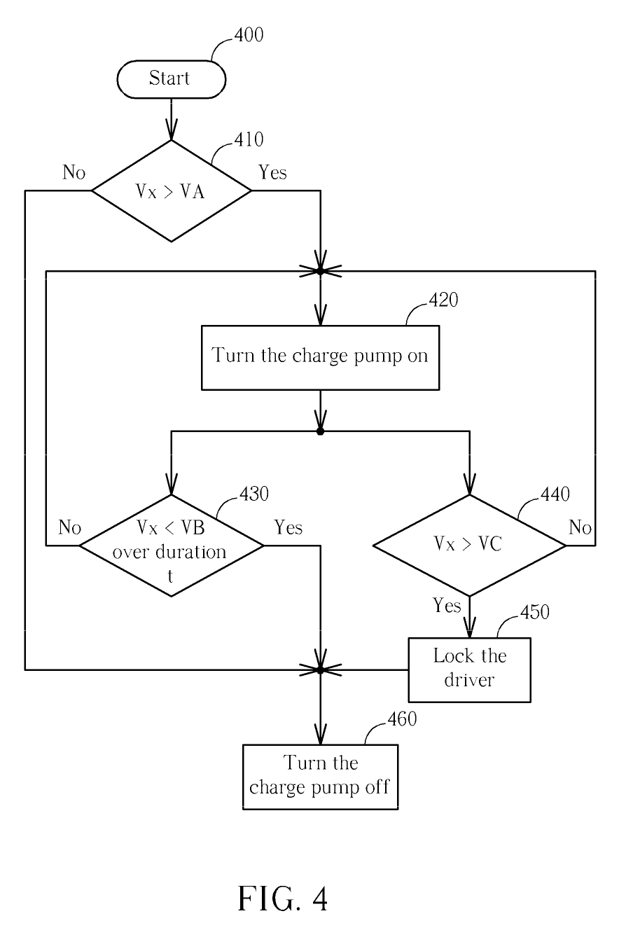

Please refer to FIG. 4. FIG. 4 is a flow chart illustrating a method of utilizing a single driver for controlling the LED charge pump driving circuit of the present invention. In this embodiment of the present invention, the LED charge pump driving circuit is shown in FIG. 2, and the circuit of the driver is shown in FIG. 3. When the LED charge pump driving circuit 20 has only one driver 26, the control circuit 24 controls the charge pump 22 and the driver 26 according to the following steps:

Step 400: Start. The control circuit 24 determines whether to turn the charge pump 22 on or off according to the loading voltage Vx of the driver 26, or locks the driver 26.

Step 410: Determine whether the loading voltage Vx is greater than a first predetermined voltage VA. When the loading voltage Vx is greater than the first predetermined voltage VA, go to Step 420. Else, go to Step 460.

Step 420: Turn the charge pump 22 on. The output voltage Vout of the charge pump 22 is greater than the input voltage Vin of charge pump 22. When the charge pump 22 reaches a stable state, go to Step 430 and Step 440.

Step 430: Determine whether the loading voltage Vx is smaller than a second predetermined voltage VB. When the loading voltage Vx is smaller than the second predetermined voltage VB over a predetermined duration t, go to Step 460. Else, go to Step 420.

Step 440: Determine whether the loading voltage Vx is greater than a third predetermined voltage VC. When the loading voltage Vx is greater than the third predetermined voltage VC, go to Step 450. Else, go to Step 420.

Step 450: Lock the driver 26; go to Step 460.

Step 460: Turn the charge pump 22 off.

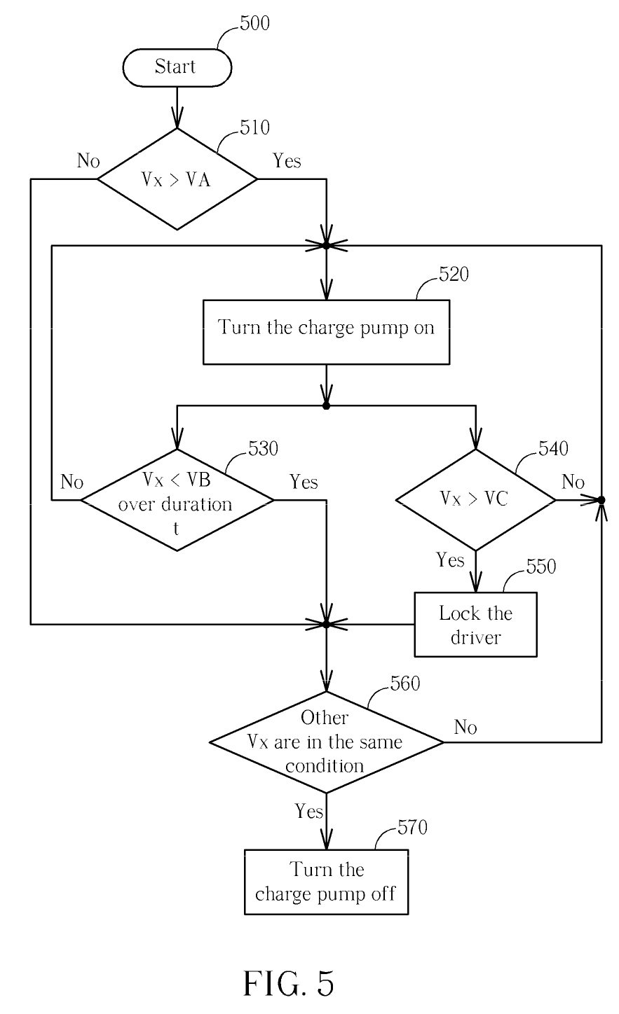

Please refer to FIG. 5. FIG. 5 is a flow chart illustrating a method of utilizing a plurality of drivers for controlling the LED charge pump driving circuit of the present invention. In an embodiment of the present invention, the LED charge pump driving circuit is shown in FIG. 2, and the circuit of the driver is shown in FIG. 3. When the LED charge pump driving circuit 20 has a plurality of drivers, the control circuit 24 controls the charge pump 22 and the driver 26 according to the following steps:

Step 500: Start. The control circuit 24 determines whether to turn the charge pump 22 on or off according to the loading voltage Vx of the plurality of drivers 26, or locks the driver 26.

Step 510: Determine whether the loading voltage Vx is greater than the first predetermined voltage VA. When the loading voltage Vx is greater than the first predetermined voltage VA, go to Step 520. Else, go to Step 560.

Step 520: Turn the charge pump 22 on. The output voltage Vout of the charge pump 22 is greater than the input voltage of the charge pump 22. When the charge pump 22 reaches the stable state, go to Step 530 and Step 540.

Step 530: Determine whether the loading voltage Vx is smaller than the second predetermined voltage VB. When the loading voltage Vx is smaller than the second predetermined voltage VB over a predetermined duration t, go to Step 560. Else, go to Step 520.

Step 540: Determine whether the loading voltage Vx is greater than the third predetermined voltage VC. When the loading voltage Vx is greater than the third predetermined voltage VC, go to Step 550. Else, go to Step 520.

Step 550: Lock the driver 26; go to Step 560.

Step 560: Determine whether the loading voltages Vx of other drivers 26 are in the same condition. If so, go to Step 570. If not, go to Step 520. Step 570: Turn the charge pump 22 off.

When the LED charge pump driving circuit 20 has the plurality of drivers 26, before turning off the charge pump 22, it is essential to confirm the charge pump 22 is not being used by other drivers 26. Therefore, as one of the loading voltages Vx of the drivers 26 is greater than the first predetermined voltage VA, the charge pump 22 is turned on. However, it is essential that all of the loading voltages Vx of the drivers 26 be smaller than the first predetermined voltage VA before the charge pump 22 is turned off. When all the loading voltages Vx of the drivers 26 are smaller than the second predetermined voltage VB over the predetermined duration t, the charge pump 22 is turned off. Additionally, when the driver 26 is locked, the control circuit 24 does not continue to make determinations according to the loading voltage Vx of the driver 26.

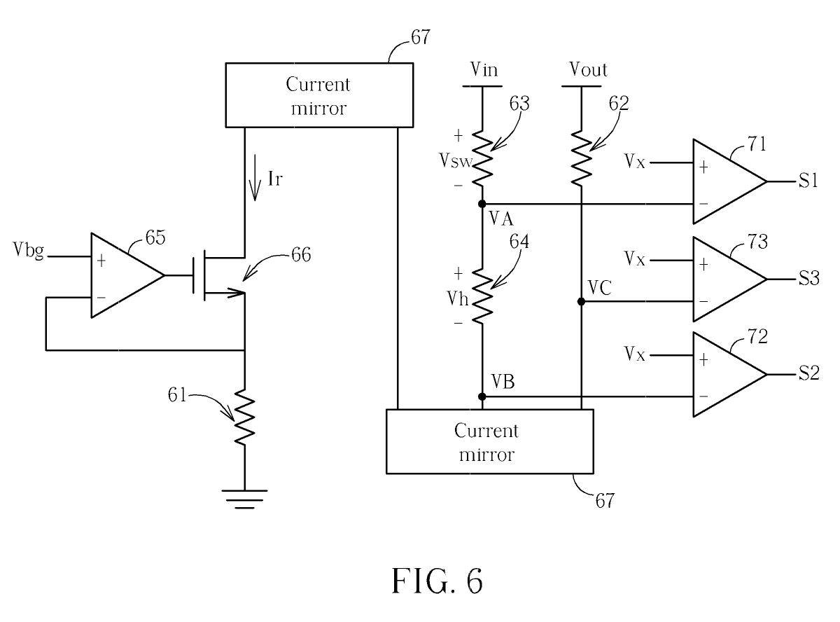

Please refer to FIG. 6. FIG. 6 is a circuit diagram of the control circuit 24 embodying FIG. 4 and FIG. 5 of the present invention. The control circuit 24 comprises a first resistor 61, a second transistor 62, a third resistor 63, a fourth resistor 64, an operational amplifier 65, an NMOS transistor 66, a current mirror 67, a first comparator 71, a second comparator 72, and a third comparator 73. A positive input end of the operational amplifier 65 receives a reference voltage Vbg. A negative input end of the operational amplifier 65 is electrically connected to the source of the NMOS transistor. An output end of the operational amplifier 65 is electrically connected to a gate of the NMOS transistor 66. A source of the NMOS transistor 66 is electrically connected to the first resistor 61. A drain of the NMOS transistor 66 is electrically connected to the current mirror 67. The operational amplifier 65 can control the NMOS transistor 66 for generating a reference current Ir according to the reference voltage Vbg and the first resistor 61. The third resistor 63 and the fourth resistor 64 are connected in series between the input voltage Vᵢₙ and the current mirror 67. The current mirror 67 provides the reference current Ir to the third resistor 63 and the fourth resistor 64 connected in series for generating the first reference voltage VA at the node A and generating the second reference voltage VB at the node B. The reference current Ir generates a voltage Vsw on the resistor 63 and generates a voltage Vh on the resistor 64. Therefore, equations of the first reference voltage VA and the second reference voltage VB respectively are represented as follows:

VA=Vin−Vsw

VB=Vin−Vsw−Vh

The first comparator 71 compares the first reference voltage VA and the loading voltage Vx for generating a first controlling signal S1. The second comparator 72 compares the second reference voltage VB and the loading voltage Vx for generating a second controlling signal S2. Consequently, the control circuit 24 turns the charge pump 22 on/off according to the first controlling signal S1 and the second controlling signal S2. The second resistor 62 is electrically connected between the output voltage and the current mirror 67. The current mirror 67 provides the reference current Ir to the second resistor 62 for generating the third reference voltage VC at the node C. The third comparator 73 compares the third reference voltage and the loading voltage Vx for generating a third controlling signal S3. Therefore, the control circuit 24 determines whether the driver 26 is open-circuited for locking the driver 26 according to the third controlling signal S3.

In conclusion, the present invention provides a method of controlling the LED charge pump driving circuit. The charge pump driving circuit comprises a charge pump, a control circuit, a driver, and an LED. The control circuit determines whether to turn the charge pump on or off according to the loading voltage of the driver and determines whether the driver is open-circuited. The charge pump generates an output voltage according to an input voltage. The driver drives the LED for generating a loading voltage according to the output voltage. When the loading voltage is greater than a first predetermined voltage, the charge pump is turned on. When the loading voltage is smaller than a second predetermined voltage over a predetermined duration, the charge pump is turned off. When the loading voltage is greater than a third predetermined voltage, the driver is locked. In another embodiment, the charge pump driving circuit comprises a plurality of drivers for driving a plurality of LEDs. When one of the loading voltages of the plurality of drivers is greater than the first predetermined voltage, the charge pump is turned on. When all of the loading voltages of the plurality of drivers are smaller than the second predetermined voltage over the predetermined duration, the charge pump is turned off.

Those skilled in the art will readily observe that numerous modifications and alterations of the device and method may be made while retaining the teachings of the invention.

What is claimed is:

1. A method of controlling an LED charge pump driving circuit, comprising:
inputting an input voltage to a charge pump for generating an output voltage;
using a driver for driving an LED for generating a loading voltage according to the output voltage;
turning the charge pump on when the loading voltage is greater than a first predetermined voltage;
turning the charge pump off when the loading voltage is smaller than a second predetermined voltage over a predetermined duration; and
locking the driver when the loading voltage is greater than a third predetermined voltage.

2. The method of claim 1, wherein the first predetermined voltage is greater than the second predetermined voltage.

3. The method of claim 1 further comprising:
generating the first predetermined voltage and the second predetermined voltage according to the input voltage.

4. The method of claim 1 further comprising:
generating the third predetermined voltage according to the output voltage.

5. The method of claim 1 further comprising:
determining whether the loading voltage is smaller than the second predetermined voltage or not after the charge pump reaches a stable state.

6. A method of controlling an LED charge pump driving circuit comprising:
inputting an input voltage to a charge pump for generating an output voltage;
using a plurality of drivers respectively for driving a plurality of LEDs according to the output voltage;
detecting voltages of the plurality of drivers for generating a plurality of loading voltages;
turning the charge pump on when one of the plurality of loading voltages is greater than a first predetermined voltage;
turning the charge pump off when all the plurality of loading voltages are smaller than a second predetermined voltage over a predetermined duration; and
locking the driver when the loading voltage of the driver is greater than a third predetermined voltage.

7. The method of claim 6, wherein the first predetermined voltage is greater than the second predetermined voltage.

8. The method of claim 6 further comprising:
generating the first predetermined voltage and the second predetermined voltage according to the input voltage.

9. The method of claim 6 further comprising:
generating the third predetermined voltage according to the output voltage.

10. The method of claim 6 further comprising:
determining whether the plurality of loading voltages is smaller than the second predetermined voltage or not after the charge pump reaches a stable state.

11. An LED charge pump driving circuit comprising:
a charge pump having an input end and an output end;
a driver electrically connected to the output end for driving an LED for generating a loading voltage;
a current mirror for providing a reference current;
a first resistor electrically connected to the input end for generating a first predetermined voltage according to the reference current;
a second resistor electrically connected to the first resistor for generating a second predetermined voltage according to the reference current;
a third resistor electrically connected to the output end for generating a third predetermined voltage according to the reference current;
a first comparator for comparing the loading voltage and the first predetermined voltage for generating a first controlling signal;
a second comparator for comparing the loading voltage and the second predetermined voltage for generating a second controlling signal; and
a third comparator for comparing the loading voltage and the third predetermined voltage for generating a third controlling signal.

12. The charge pump driving circuit of claim 11 further comprising:
a control circuit electrically connected the charge pump and the driver for turning the charge pump on/off according to the first controlling signal and the second controlling signal and locking the driver according to the third controlling signal.
